(19) United States
(12) Patent Application Publication
(10) Pub. No.: US 2012/0314283 A1
(43) Pub. Date: Dec. 13, 2012

(54) TELESCOPIC GUN SIGHT WITH MAGNIFICATION-INVARIANT RETICLE

(76) Inventor: Omid Jahromi, McLean, VA (US)

(21) Appl. No.: 13/156,298

(22) Filed: Jun. 8, 2011

(51) Int. Cl. G02B 23/00

(52) U.S. Cl. 359/422; 359/428

(57) ABSTRACT

This invention teaches a telescopic gun sight with a reticle placed at the first focal plane such that the apparent size of the reticle remains substantially invariant when the sight's magnification is changed. According to one embodiment, a telescopic gun sight comprises an objective lens, a magnification-invariant reticle, an image relay means with variable magnification, and an eye piece. The magnification-invariant reticle is designed in accordance to the invention such that its apparent size is not affected by change in the sight's magnification. This invention combines the benefits of telescopic gun sights with first focal plane reticle and second focal plane reticle in a single design.

### I. CROSS-REFERENCE TO RELATED APPLICATIONS

Not Applicable

### II. FEDERALLY SPONSORED RESEARCH

Not Applicable

### III. SEQUENCE LISTING OR PROGRAM

Not Applicable

### IV. FIELD OF THE INVENTION

This application relates to telescopic gun sights. More specifically, this invention relates to telescopic gun sights having variable magnification and a reticle mounted at the objective focal plane.

### V. BACKGROUND OF THE INVENTION

A telescopic gun sight, commonly called a rifle scope, is a device used to provide an accurate point of aim for firearms such as rifles, handguns and shotguns. A telescopic sight significantly improves the functionality of a firearm by providing the shooter with a simple yet highly accurate means for aiming at distant targets.

A telescopic sight is essentially a Keplerian telescope with an added reticle to designate the point of aim. Reticles are most commonly represented as intersecting lines called “cross hairs” though many variations exist, including dots, posts, circles, scales, chevrons, etc. A basic telescopic sight is shown schematically in FIG. 1. With reference to this figure, a telescopic sight comprises an objective lens 1 to form a first image of the target at (or near) the objective focal plane 2. This first image is laterally reversed and upside-down. An image relay means, shown in FIG. 1 comprising of a pair of convex lenses 3a and 3b, takes this first image and produces a laterally-correct and up-right second image at the eyepiece focal plane 4. Finally, an eyepiece 5 converts the second image into a virtual image at infinity for viewing by the shooter.

To provide variable magnification (zoom), the positions of the relay lenses 3a and 3b are individually shifted along the optical axis. This is usually done by placing the entire image relay means inside a rotating inner tube which has a set of precisely calculated slots cut in its surface. A cam system connected to these slots moves each relay lens back and force as said inner tube rotates. Details of the mechanical construction of the zoom mechanism is not essential in understanding the nature or benefits of the present invention and is not shown in FIG. 1.

To designate the point of aim, a reticle is placed either at the objective focal plane or at the eyepiece focal plane. These two planes are also referred to as the First Focal Plane (FFP) and the Second Focal Plane (SFP), respectively. In either case, the reticle's shape will appear superposed on the target image providing a precise indication of the point of aim. The difference is that if the reticle is placed at the objective focal plane, it appears to enlarge and shrink along with the target image as the sight's magnification is changed. If the reticle is placed at the eyepiece focal plane, its size appears constant at all magnifications. In FIG. 1, the reticle 20 is placed at the objective focal plane 2.

Traditionally, European designs have placed the reticle at the first focal plane. In this configuration the reticle and the image of the target are enlarged or reduced simultaneously as the sight's magnification is changed. This keeps the scale factor between the reticle and the target image unchanged, thus allowing the reticle to be used as a range finding aid. Another benefit of rifle scopes with first focal plane reticle is that their aiming precision is not affected by the mechanical imperfections of the zoom mechanism. In refile scope with second focal plane reticle, even a very small change in the concentricity of the moveable relay lenses can change the point of aim during zoom.

Most American shooters prefer that the reticle remains constant as the target image changes size. Therefore, many variable-magnification telescopic sights sold or manufactured in the United States have reticles in the second focal plane. This allows the shooter to aim very well at small targets at long distances because the reticle obscures only a tiny portion of the target image at high magnifications. Rifle scopes with low magnification, such as those intended for hunting dangerous game at short ranges, are also well-suited to this design. When set at the lowest magnification for the wildest field of view, the reticle remains thick enough allowing fast and reliable target acquisition.

It is evident from the preceding discussion that a rifle scope with FFP reticle is far superior to one with SFP reticle in terms of accuracy and usability as a range-finding device. The only draw back of a rifle scope with FFP reticle is that the reticle could appear too small (therefore difficult to see) at low magnification and too large (therefore obscuring the field of view) at high magnification. This phenomenon is illustrated in FIG. 2. In this figure, a popular reticle design commonly known as “German No. 4” is shown as it appears in an FFP rifle scope. On the left hand side, the reticle is shown as it appears at low magnification (e.g, zoom knob set to 3×). On the right hand side, the same reticle is shown as it would appear at 4 times higher magnification (e.g., zoom knob set to 12×). It is clear from this illustration that for FFP rifle scopes with a large zoom range, excessive reticle enlargement and shrinkage becomes a major problem. For this very reason, a famous European manufacturer (Sawrovski Optik of Tyrol, Austria) has completely abandoned offering first focal plane models in its new line of rifle scopes.

The present invention teaches a telescopic sight with a first focal plane reticle that appears invariant (or almost-invariant) at various zoom scales. This invention thus overcomes the limitations of the prior art by combining the benefits of a rifle scope having a first focal plane reticle (precise aiming and range finding capability at all zoom scales) and a rifle scope having a second focal plain reticle (constant reticle size). Furthermore, the present invention achieves these benefits simply and inexpensively without any additional manufacturing cost.

Many different shapes and patterns have been proposed for reticles in the past. We refer the reader to U.S. Pat. No. 7,100,320B2 issued Sep. 5, 2006 to E. A. Verdugo; U.S. Pat. No. 6,729,062B2 issued May, 4, 2004 to R. L. Thomas and C. Thomas; U.S. Pat. No. 6,681,512B2 issued Jan. 27, 2004 to D J Sammut; U.S. Pat. No. 3,948,587 issued Apr. 6, 1976 to P. E. Rubbert and references therein for examples of prior art.

Examples of commercially available reticle patterns can be found in the catalogs and websites of rifle scope manufacturers including Carl Zeiss (www.zeiss.com.), Swarovski Optik (www.swarovskioptik.us), Schmidt and Bender (www.schmidtbender.com.), Night Force Optics (www.nightforceoptics.com.), Horus Vision (www.horusvision.com), Leupold (www.leupold.com) and so on.

While the reticles invented to this date accomplish their individual objectives, they do not describe a reticle that appears substantially invariant to magnification when used in a zoom FFP rifle scope. The concept of magnification invariance introduced in this invention is a fundamentally new design concept and represents a significant departure from all the design concepts previously used in the prior art.

### VI. SUMMARY OF THE INVENTION

The present invention teaches a telescopic gun sight whose reticle is placed at the first focal plane yet it appears substantially invariant or near-invariant at different magnifications. In accordance with one embodiment, this invention introduces a variable-magnification telescopic gun sight comprising an objective lens, a magnification-invariant reticle, an image relay means, and an eyepiece; wherein said reticle is comprised of a plurality of posts in the form of circular sectors so that the apparent shape of the reticle remains invariant at various magnification settings.

### VII. BRIEF DESCRIPTION OF THE DRAWINGS

The foregoing aspects and many of the attendant advantages of this invention will become more readily apparent with reference to the following detailed description of the invention, when taken in conjunction with the appended claims and accompanying drawings, wherein:

FIG. 1 is a side-view schematic of a variable-magnification rifle scope.

FIG. 2 is a diagram illustrating reticle size variation in conventional first focal plane rifle scopes.

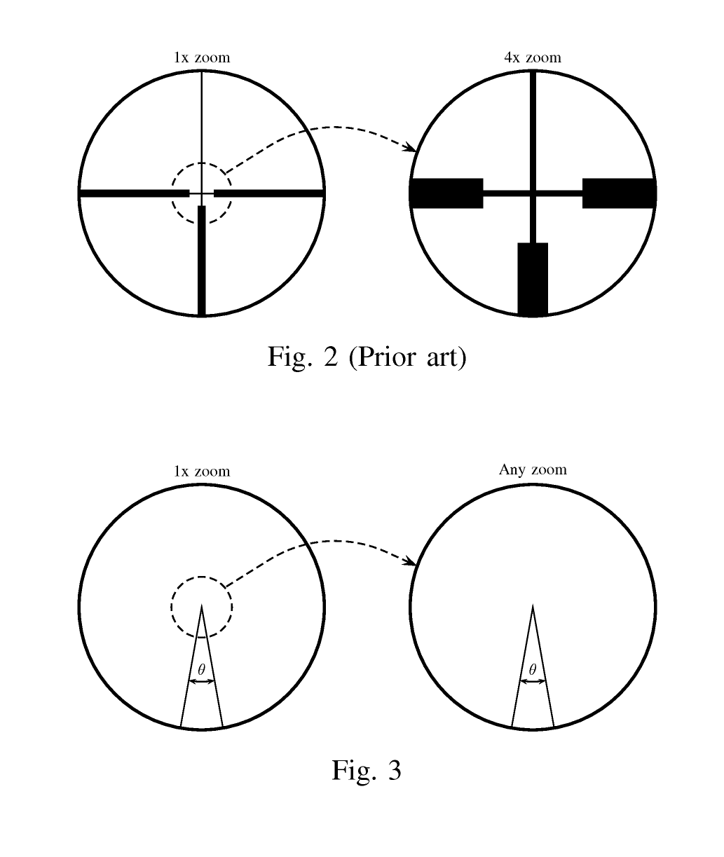

FIG. 3 is a diagram illustrating the magnification-invariance property of a circular sector.

FIGS. 4a to 4d depict a plurality of magnification-invariant reticles in accordance with a first embodiment of the invention.

FIG. 5 is a diagram illustrating the general design of an almost-magnification-invariant reticle in accordance with a second embodiment of the invention.

FIGS. 6a to 6f illustrate a sample almost-magnification-invariant reticle, its angular profile, and its appearance at various magnification scales, in accordance with the second embodiment of the invention.

FIGS. 7a to 7f illustrate a conventional “plex” reticle, its angular profile, and its appearance at various magnification scales for comparison purposes.

FIGS. 8a and 8b illustrate an almost-magnification-invariant reticle which uses a variation of the designs described in the first and the second embodiments of the invention.

FIGS. 9a and 9b illustrate another almost-magnification-invariant reticle which uses a variation of the designs described in the first and the second embodiments of the invention.

### VIII. DETAILED DESCRIPTION OF THE INVENTION

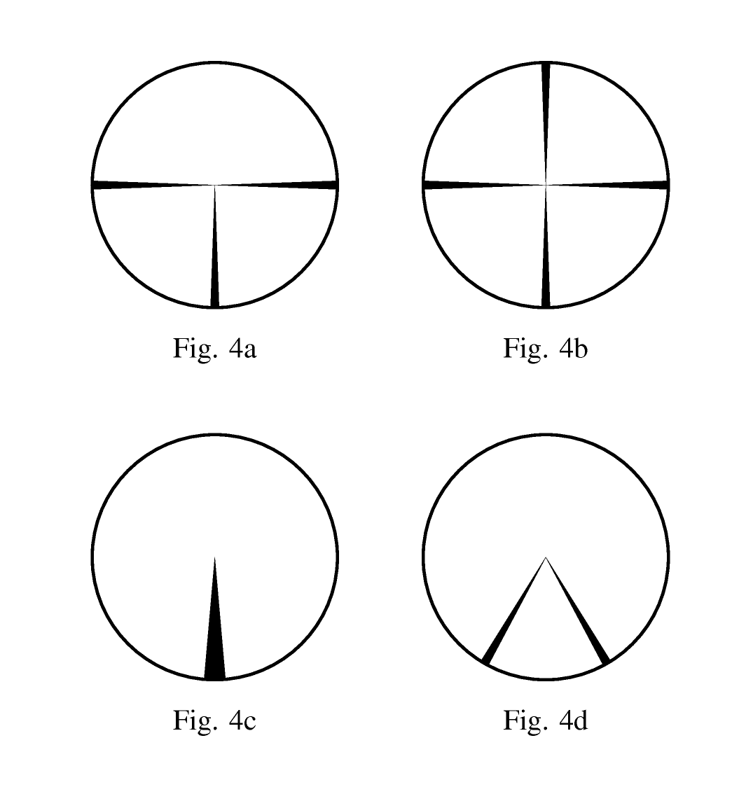

This invention is inspired by a fundamental geometrical property of circular sectors. In geometry, a circular sector or circle sector is defined as the portion of a circle enclosed by two radii and an arc. A circular sector has the property that its central angle is preserved under magnification. This phenomenon is illustrated in FIG. 3. As shown in this figure, the central angle θ of a circular sector is preserved if the central part of the circle is enlarged using an image-magnifying device.

In this invention we use the above mentioned geometric principle to construct reticle patterns that remain invariant under zoom when placed in the first focal plane of a rifle scope. Details of the arrangement of elements characterizing the invention will be more fully understood from the description of preferred embodiments and with reference to the accompanying drawings.

### A. First Embodiment of the Invention

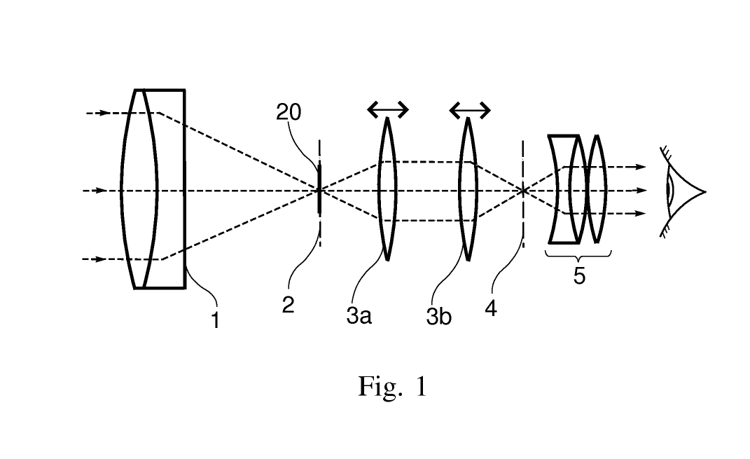

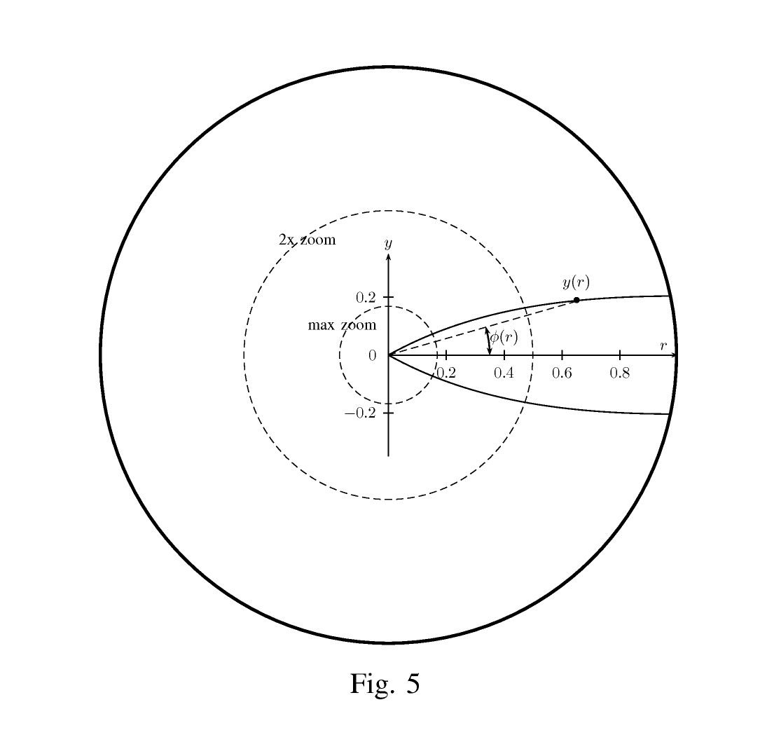

In accordance with a first embodiment of the invention, a zoom telescopic gun sight comprises an objective lens, a magnification-invariant (MI) reticle, an image relay means with variable magnification, and an eye piece. FIG. 1 shows a side-view schematic illustrating the arrangement of the elements in accordance to the first embodiment of the invention. FIGS. 4a to 4d depict a plurality of MI reticle shapes in accordance to the first embodiment of the invention.

With reference to FIG. 1, the objective lens 1 forms a first image of a distant target at the objective focal plane 2. This first image is laterally reversed and upside-down. An image relay means, shown symbolically in FIG. 1 comprising of a pair of convex lenses 3a and 3b, takes the first image formed by the objective lens and produces a laterally-correct and up-right second image at the eyepiece focal plane 4. Finally, an eyepiece 5 converts the second image into a virtual image at infinity for viewing by the shooter.

With reference to FIG. 1, the first embodiment of the invention further includes an MI reticle 20 placed at the objective focal plane 2. The MI reticle 20 is comprised of one or more posts. Each post is in the form of a circular sector or “wedge” originating from the center of field of view and extending to its edge. Four example reticle patterns that are in accordance with this design are shown in FIGS. 4a to 4d.

FIG. 4a shows an MI reticle comprising two horizontal posts and a vertical post where each post is a circular sector with small central angle. The point of aim is at the center of field of view where the three sectors meet. This MI reticle is suitable for general hunting or tactical applications. The position of posts in this MI reticle has been inspired by the popular “German No. 4” reticle used in many European rifle scopes.

The MI reticle in FIG. 4b is similar to the previous reticle except that it has an additional post on the top. The position of posts in this MI reticle resembles the popular “plex” reticle used in many American rifle scopes.

The MI reticle in FIG. 4c is comprised of a single vertical wedge extending from the bottom to the center of field of view. This vertical post is in the form of a circular sector with somewhat wider central angle compared to those used in FIGS. 4a and 4b. This MI reticle is particularly suited for hunting running game and for tactical applications involving Close-Quarter Combat (CQB).

The MI reticle in FIG. 4d shows another useful arrangement where two circular sectors each with a relatively small central angle are arranged in an inverted V formation. This MI reticle is also suited for tactical and CQB applications. The advantage of this pattern is that there is some open space immediately below the point of aim. This space can be used for placing additional markings or other indicators for range finding or bullet drop compensation.

The patterns shown in FIGS. 4a to 4d are illustrative examples of MI reticles that can be constructed in accordance with the first embodiment of the invention. These reticles are perfectly magnification-invariant in the sense that their shape and size appears constant once implemented at the first focal plain of a telescopic gun sight in accordance to the invention.

### B. Second Embodiment of the Invention

The telescopic sight described in the first embodiment of the invention has the property that its reticle size appears completely unchanged at any zoom range. While very interesting from an engineering point of view, this level of invariance is not always necessary in practice. In many hunting situations it is sufficient that the reticle remains thin enough at high zoom (not to obstruct the field of view) and thick enough at low zoom (easily visible against the background). In this embodiment we describe a zoom telescopic sight with first focal plane reticle such that the reticle size appears sufficiently unchanged for a finite zoom range.

In accordance with the second embodiment of the invention, a zoom telescopic gun sight comprises an objective lens, an almost-magnification-invariant (AMI) reticle, an image relay means with variable magnification, and an eye piece. The arrangement of the elements and their function is similar to the first embodiment of the invention. The only difference is the shape of the AMI reticle as described below.

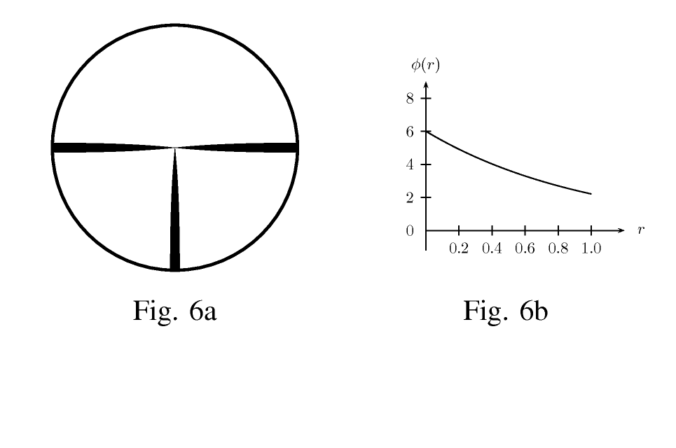

The general design of an AMI reticle in accordance to the second embodiment of the invention can be understood using the illustration in FIG. 5. In this figure, the telescopic sight's field of view at its lowest magnification is represented by a circle with normalized radius of one unit. A Cartesian coordinate system is defined within this circle. The horizontal coordinate r and the vertical coordinate y are chosen such that the center of the coordinate system is at the center of the field of view. When the sight's magnification is increased, the field of view is reduced proportionally. Let's assume, for the sake of simplicity, that the sight's minimum magnification is 1× and its maximum magnification is 6×. As the user increase the zoom for this sight he will observe that the field of view will reduce to a circle with radius r=0.5 at magnification 2× and to a circle with radius r=⅙ at maximum magnification 6×. These two circles are shown in FIG. 5 using dashed lines.

An AMI reticle is comprised of one or more AMI posts. An AMI post has a central axis which is a radius of the circle and two perimeters. Each perimeter may be defined by a linear characteristic function y(r) which represents the half-thickness of the post (measured perpendicular to the central axis) as a function of normalized radial distance. An example AMI post is drawn in FIG. 5. Here, the central axis of the AMI post is the same as the horizontal axis and the post's upper and lower perimeters are assumed to be symmetric with respect to its central axis r.

Alternatively, the primeters of an AMI post can be defined using an angular characteristic function φ(r). The angular characteristic function φ(r) measures the angular separation between each point on a perimeter of an AMI post with respect to its central axis. The center of the angle is at the center of field of view. The angular characteristic function φ(r) is illustrated in FIG. 5 as well.

Each point on the perimeter of a post can be uniquely specified either by the linear characteristic function y(r) or by the angular characteristic function φ(r). It is easy, using elementary trigonometry, to show that y(r)=r tan(φ(r)).

In this embodiment, the angular characteristic function φ(r) is used to design preferred AMI posts. This is because φ(r) shows how various parts of a post expand at various zoom scales. To see this, consider the post shown in FIG. 5 and assume that the sight's maximum zoom range is M. During zoom, the outer parts of the post for which 1/M≦r≦1 will move towards the edge of field of view along a radial direction with azimuth angle φ(r). These parts of the post will reach a maximum half-thickness of tan(φ(r)) just before moving out of the field of view. The inner parts of the post for which 0<r≦1/M will also grow during zoom and move towards the edge of the field of view along a radial direction with azimuth angle φ(r). However, these parts will remain visible and will enlarge to a maximum half-thickness given by Mr tan(φ(Mr)).

An MI post is produced when φ(r) is constant for 0≦r≦1. In this case the posts will be wedge-shaped as described in the first embodiment of the invention. Such a post will grow “on itself” during zoom therefore appearing invariant. An AMI post is achieved when φ(r) is allowed to change a small amount as r changes. A preferred AMI post in accordance to this embodiment is achieved when φ(r) has higher values near r=0 and lower values when r approaches 1. An AMI post designed this way will have a thicker tip near the center of the field of view and will be more easily visible at low zoom.

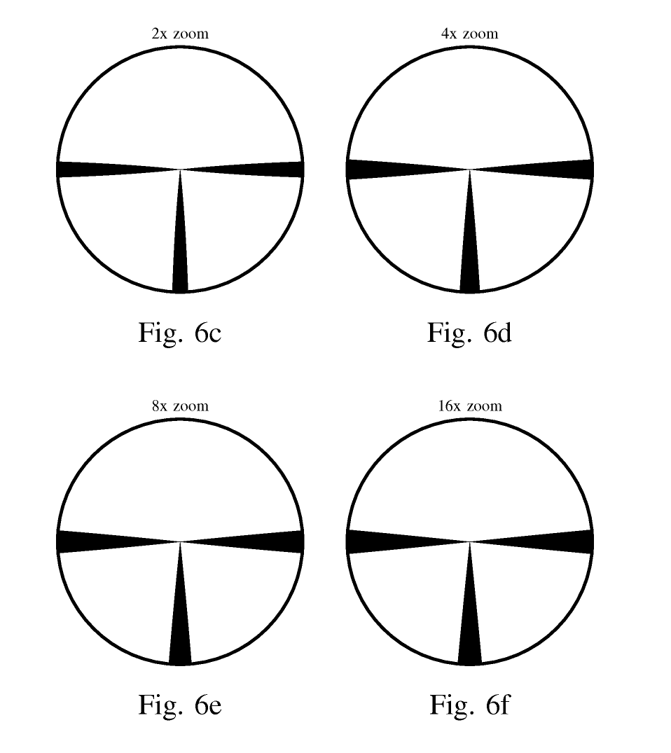

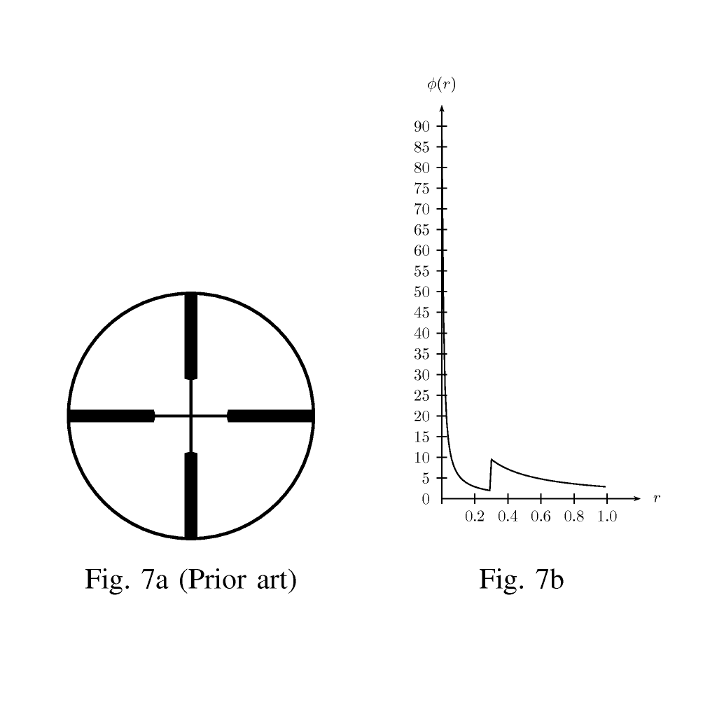

An example AMI reticle utilizing this angular characteristic is shown in FIG. 6a. The angular characteristic function φ(r) associated with this design is depicted in FIG. 6b. Here φ(r) is designed to start at 6 degrees for r=0 and slowly decrease to 2 degrees at r=1. FIGS. 6c to 6f illustrate how this reticle appears at various zoom scales up to 16×. For comparison, FIGS. 7c to 7f show how the conventional plex reticle shown in FIG. 7a enlarges at the same zoom scales. It is clear from this comparison that the AMI reticle enlarges much less than the conventional plex reticle during zoom. For comparative purposes, the angular characteristic function associated with the conventional plex reticle is also shown (See FIG. 7b).

Persons skilled in the art may use the methodology described above to design many different forms of AMI reticles. The design is carried out by choosing a proper form for the angular characteristic function φ(r). The general guideline is to have φ(r) start at a higher value near r=0 and slowly take smaller values as r approaches 1.

### C. Advantages

Based on the above descriptions of some embodiments of the invention, a number of advantages of one or more aspects over existing sights are readily apparent:
1. The reticle is placed in the first focal plane which guarantees that the point of aim is not affected when magnification is changed and the reticle occupies substantially the same (or almost the same) area within the field of view when magnification is changed.
2. There is little extra design cost. The MI and AMI reticles can be retro-fitted in existing telescopic sights.
3. There is no extra manufacturing cost. In fact, a single MI or AMI design can be used in many rifle scope models irrespective of individual scope's magnification or zoom range.

These and other advantages of one or more aspects may now be apparent to the reader from a consideration of the foregoing description and accompanying drawings.

### IX. CONCLUSION, RAMIFICATIONS, AND SCOPE

The foregoing description of the specific embodiments will so fully reveal the general nature of the invention that others can, by applying knowledge within the skill of the art, readily modify and/or adapt for various applications such specific embodiments, without undue experimentation, without departing from the general concept of the present invention.

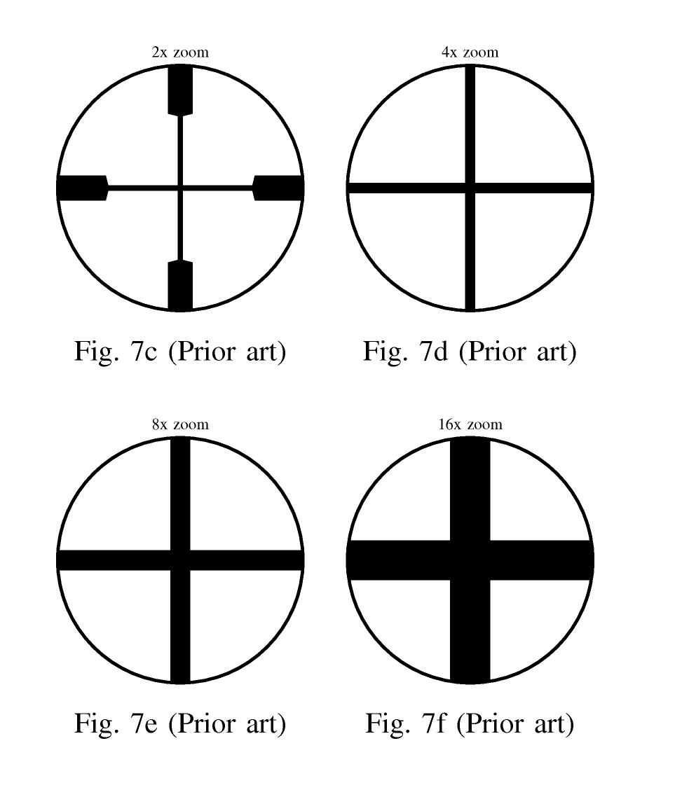

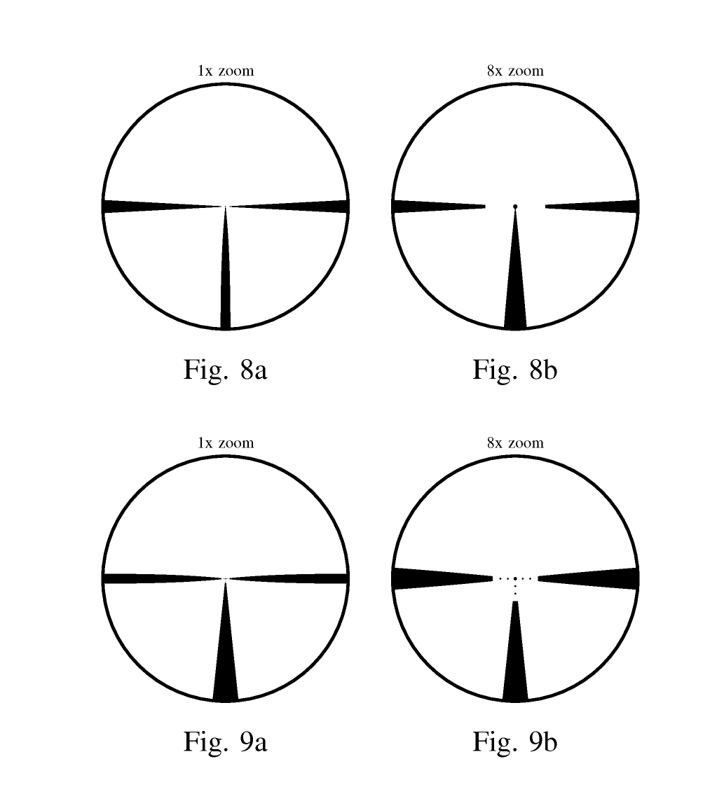

While the above descriptions of the present invention contain numerous specificities, they should not be construed as limiting the scope of the invention, but as mere illustrations of some of the preferred embodiments thereof. Many other ramifications and variations are possible within the expositions of the various embodiments. For example:
1. It is possible to combine MI and AMI posts in the same reticle to suite specific needs. It is also possible to remove small parts from some posts and/or add some extra markings to make aiming easier. An example of this variation in shown in FIGS. 8a and 8b. The reticle shown here has two horizontal MI posts and a vertical AMI post. A small part from the tip of the MI posts has been removed and a small circle has been added to the tip of the AMI post to improve its visibility and facilitate aiming
2. Markings for bullet drop indication or range-finding may be added to AMI or MI reticles. An example of this variation in shown in FIGS. 9a and 9b. The reticle shown here has two horizontal AMI posts and a vertical MI post. A small part from the tip of all three posts has been removed and small dots have been added. These dots are not visible at low magnification hence the sight is well-suited for Close Quarter Combat. The dots become visible at high magnification and can help the shooter adjust his point of aim for wind and bullet drop when aiming at distant targets.

Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance. Thus, the scope of the invention should be determined by the appended claims and their legal equivalents, as opposed to the embodiments illustrated.

What is claimed is:

1. A zoom telescopic sight for designating a weapon's point of aim when pointed at a target, comprising:
a. an objective lens for forming a first image of the target, said objective lens having a focal plane, said first image providing a finite field of view around said target,
b. an image relay means for converting said first image into an upright and laterally-correct second image, said image relay means being positioned opposite said objective lens, said image relay means having variable magnification, said magnification being adjustable by an operator,
c. an eyepiece lens for converting said second image into a virtual third image of the target, said eyepiece lens being positioned opposite said image relay means,
d. a reticle for indicating the point of aim, said reticle being positioned coplanar with the objective focal plane, and
e. said reticle comprising at least one post, said post being in the form of a circular sector enclosed by two radii meeting at the center of the field of view,
whereby said operator can view and use said third image of the target for the purpose of aiming and the reticle's apparent size remains unchanged when said operator adjusts said magnification.

2. The telescopic sight of claim 1, wherein a small portion of at least one post near the center of the field of view is removed.

3. The telescopic sight of claim 1, further including a small dot, said dot being added to the reticle at the center of field of view.

4. The telescopic sight of claim 2, further including a small dot, said dot being added to the reticle at the center of the field of view.

5. The telescopic sight of claim 1, further including a set of markings added to the reticle near the center of the field of view, said markings being used for the purpose of bullet drop calculation.

6. The telescopic sight of claim 2, further including a set of markings added to the reticle near the center of field of view, said markings being used for the purpose of bullet drop calculation.

7. The telescopic sight of claim 3, further including a set of markings added to the reticle near the center of field of view, said markings being used for the purpose of bullet drop calculation.

8. A zoom telescopic sight for designating a weapon's point of aim when pointed at a target, comprising:
a. an objective lens for forming a first image of the target, said objective lens having a focal plane, said first image providing a finite field of view around said target,
b. an image relay means for converting said first image into an upright and laterally-correct second image, said image relay means being positioned opposite said objective lens, said image relay means having variable magnification, said magnification being adjustable by an operator,
c. an eyepiece lens for converting said second image into a virtual third image of the target, said eyepiece lens being positioned opposite said image relay means,
d. a reticle for indicating the point of aim, said reticle being positioned coplanar with the objective focal plane, and
e. said reticle comprising at least one post, said post having a central axis, said post being formed by the area between two convex curves, said convex curves being located on opposite sides of said central axis, said convex curves originating from the center of field of view and extending to its edge, said convex curves each being defined by an angular characteristic function, said angular characteristic function specifying the central angle subtended between each point on said convex curves and said central axis, said angular characteristic function specifying said central angle as a function of radial distance from the center of field of view, said angular characteristic function being a non-increasing function of said radial distance,
whereby said operator can view and use said third image of the target for the purpose of aiming and the reticle's apparent size remains relatively unchanged when said operator adjusts said magnification.

9. The telescopic sight of claim 8, wherein a small portion of at least one post near the center of the field of view is removed.

10. The telescopic sight of claim 8, further including a small dot, said dot being added to the reticle at the center of the field of view.

11. The telescopic sight of claim 9, further including a small dot, said dot being added to the reticle at the center of the field of view.

12. The telescopic sight of claim 8, further including a set of markings added to the reticle near the center of the field of view, said markings being used for the purpose of bullet drop calculation.

13. The telescopic sight of claim 9, further including a set of markings added to the reticle near the center of field of view, said markings being used for the purpose of bullet drop calculation.

14. The telescopic sight of claim 11, further including a set of markings added to the reticle near the center of field of view, said markings being used for the purpose of bullet drop calculation.
